(19) United States
(12) Patent Application Publication
(10) Pub. No.: US 2002/0113384 A1
(43) Pub. Date: Aug. 22, 2002

(54) Structure for mounting snowboard bindings

(76) Inventor: Hajime Kasai, Tokyo-To (JP)

Correspondence Address: SMITH, GAMBRELL & RUSSELL, LLP, 1850 M STREET, N.W., SUITE 800, WASHINGTON, DC, 20036, US

(21) Appl. No.: 10/078,358

(22) Filed: Feb. 21, 2002

(30) Foreign Application Priority Data
Feb. 22, 2001 (JP) 2001-47105

(51) Int. Cl. B62M 29/00

(52) U.S. Cl. 280/14.21

(57) ABSTRACT

To provide a structure for mounting snowboard bindings for turning a snowboard in the direction in which a rider intends to go without limiting flex, and for increasing the riding performance of the snowboard, the structure for mounting bindings comprises outer fixing sections having highly rigid supporting bars and highly rigid mounting bars, and inner fixing sections having highly flexible soft mounting parts. Since the outer fixing sections are provided so as to cross the snowboard and almost reach the edges of the snowboard, shifting the direction of the weight of the rider is directly transmitted to the edges, and as a result, high riding performance can be achieved. In addition, because the shapes of the soft mounting parts vary according to the direction of the weight of the rider during riding, the snowboard can be fully bent and can be turned in the direction in which a rider intends to go.

### BACKGROUND OF THE INVENTION

1. Field of the Invention

The present invention relates to a structure for mounting snowboard bindings.

2. Description of Related Art

A snowboard is provided with bindings for fixing boots. As shown in FIG. 7a, a type of related structure for mounting snowboard bindings where screw holes (not shown) are formed in a snowboard 1 and bindings 2, 2 are directly fixed thereto by using screws 3, 3 is often used.

However, in the structure for mounting bindings in FIG. 7a, rigid body bindings made from aluminum alloys or hard resins are directly screwed into the snowboard 1, causing the rigidity at these screwed portion to become higher than that of the other parts. As a result, flex (bendability in the lengthwise direction) of the snowboard during riding is limited, and flexibility of the snowboard itself can not be fully exhibited. Therefore, there are problems such as the shape of the turning arc that a rider generates becomes different from that the rider intended, or an edge of the snowboard contacting the snow surface partially works as a brake.

Therefore, as shown in FIG. 7b, a type of snowboard has been developed where mounting members 4, 4 made of relatively soft resin or rubber are fixed on the snowboard 1, and the bindings 2, 2 are mounted on the mounting members 4, 4. In such a structure, the flex of the snowboard during riding is not limited and the desired turning arc is maintained. However, since the mounting members 4, 4 are formed of soft material, it is easily deformed, and although the rider shifts the direction of weight to change the direction of a turn, the transmission of the weight shift to the snow surface is delayed due to the deformation of the mounting members 4, 4. The direct movement feeling of riding is thus lost, and swift weight shift or quick change of turns becomes difficult, and as a result, the turning performance of the snowboard itself is impaired.

The aim of the present invention is, in a structure for mounting snowboard bindings, to make it possible to turn a snowboard in the direction in which a rider intends to go without limiting natural flex of the snowboard, and to improve the riding performance of the snowboard.

### SUMMARY OF THE INVENTION

In order to solve the above problems, for example, as shown in FIG. 1, a structure for mounting bindings for mounting the bindings on a snowboard, described in claim 1, is provided with: a pair of first mounting seats (outer fixing sections) made of hard members provided on the snowboard in a lengthwise direction being separated from each other by a prescribed distance; and a pair of second mounting seats (inner fixing sections) made of soft deformable members provided at inner sides of the first mounting seats.

According to the structure for mounting bindings of claim 1, the outer sides of the bindings are mounted on the first mounting seats made of hard members and inner sides of the bindings are mounted on the second mounting seats made of soft members. Therefore, since the outer sides of the bindings are mounted on the snowboard via the first highly rigid mounting seats, shifting the direction of the weight of a rider is directly transmitted to the snowboard, and the snowboard is directly responsive to a turn in the horizontal direction, as a result, highly responsive performance can be achieved.

Since the inner sides of the bindings are mounted on the snowboard via the second soft mounting seats, the shape of the second mounting seats freely varies according to the direction of the weight of the rider during riding, and flex of the snowboard is not impeded. As a result, the turning arc can be maintained as the rider intends.

In addition, because the first highly rigid mounting seats are provided at the outer side on the snowboard and the second highly flexible mounting seats are provided at the inner side on the snowboard, soles of both feet are naturally tilted toward the soft inner side or the center side of the rider when the rider applies pressures to both feet, and thus the center of gravity of the rider naturally becomes the center of the snowboard, allowing the rider to maintain a stable position.

As described above, according to the structure for mounting bindings of claim 1, by combining the first highly rigid mounting seats and the second highly flexible mounting seats, not only can the snowboard be fully bent and turned in the direction in which the rider intends to go, but it also shows quick a response and the riding performance can be improved.

In claim 1, each of the first mounting seats and the second mounting seats need not necessarily be formed from one member and may be formed from a plurality of members.

Also, material and shape of each of the first mounting seats and the second mounting seats are not particularly limited as long as specified hardness, flexibility and strength is obtained. However, it is preferable to use, for example, the material and the shape described in claim 2.

Namely, the invention described in claim 2 is, in the structure for mounting the snowboarding bindings of claim 1, that the first mounting seats are mainly made of either aluminum alloy, titanium alloy, or hard synthetic resin and formed into a bar shape or a plate shape, and that the second mounting seats are mainly made of either rubber or polymeric elastomer and formed into a cylindrical shape or a elliptical shaft shape.

### BRIEF DESCRIPTION OF THE DRAWINGS

FIG. 1 is a perspective view showing a first embodiment of a structure for mounting snowboard bindings of the present invention, with tront and rear ends of a snowboard omitted.

FIG. 2 is a cross-sectional view showing an outer fixing section of the structure for mounting the bindings of FIG. 1.

FIG. 3 is a cross-sectional view showing an inner fixing section of the structure for mounting the bindings of FIG. 1.

FIG. 4 is a perspective view showing the second embodiment of the structure for mounting the snowboard bindings of the present invention, with front and rear ends of the snowboard omitted.

FIG. 5 is a cross-sectional view showing the outer fixing member of the structure for mounting the bindings of FIG. 4.

FIG. 6 is a cross-sectional view showing another example of an insert nut in a soft mounting part.

FIG. 7 is a perspective view, both a and b of which show the related structure for mounting the snowboard bindings, with the front and rear ends of the snowboard omitted.

### DETAILED DESCRIPTION OF THE PREFERRED EMBODIMENTS

First Embodiment

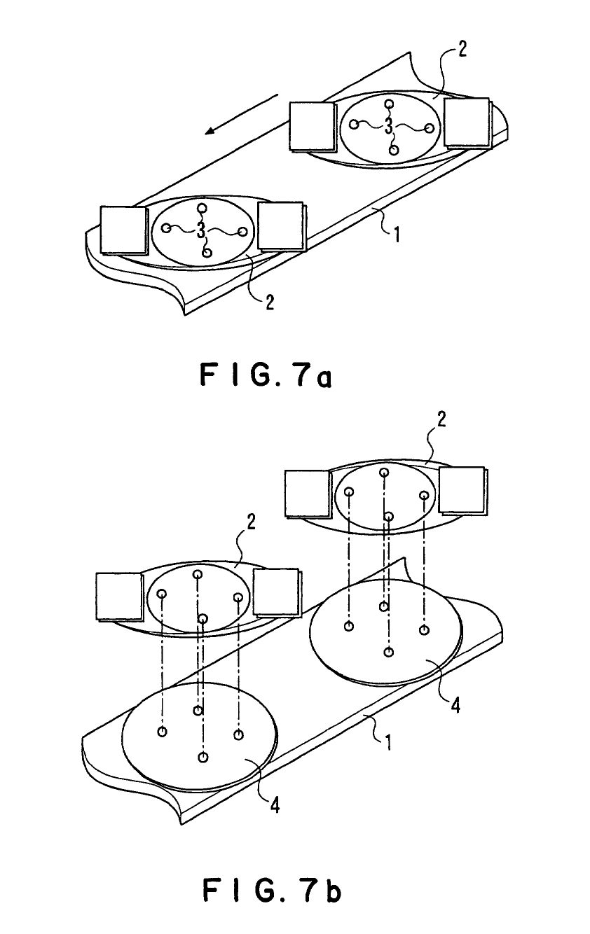

The following is a detailed description, with reference to FIGS. 1 to 6, of embodiments of the present invention. In the drawings, bindings are shown by dotted lines, and the same numerals are used for the same members as those in FIG. 7.

A structure for mounting bindings 10 on a snowboard is shown in FIG. 1 as an example of the present invention.

The structure for mounting bindings 10 comprises a front mounting section 10a for a front foot and a rear mounting section 10b for a rear foot, being separated from each other by a prescribed distance.

Either of the front mounting section 10a and the rear mounting section 10b is made up of an outer fixing section 11 and an inner fixing section 15 provided at the inner side of the outer fixing section 11.

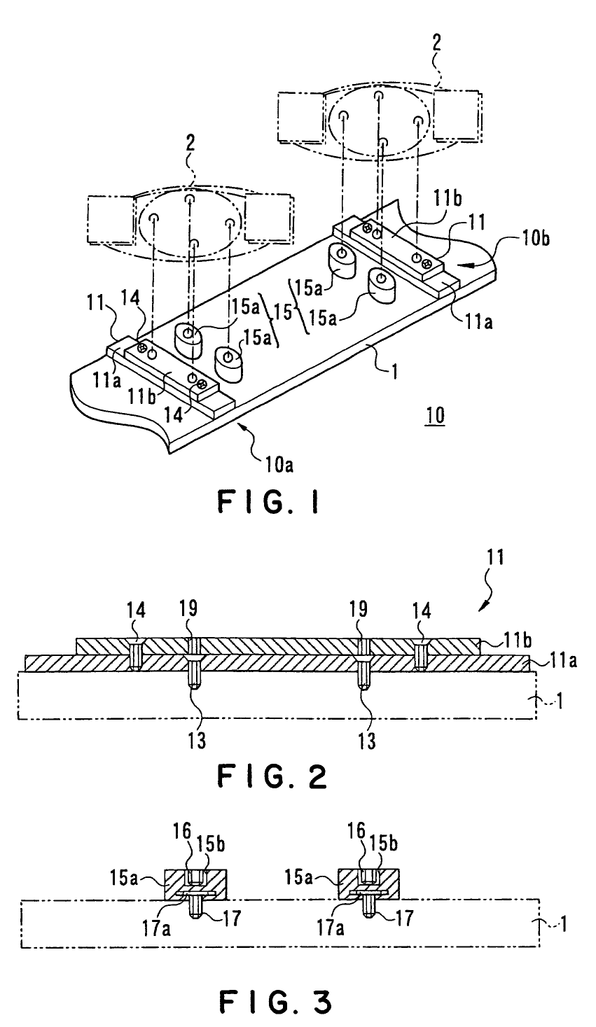

FIG. 2 shows a cross-sectional structure of each outer fixing section 11. The outer fixing section 11 is the first mounting seat of the present invention, is made by combining a mounting bar 11b on top of a supporting bar 11a, and is provided in the widthwise direction to cross a snowboard 1. The supporting bar 11a and the mounting bar 11b are both obtained by forming highly rigid material such as aluminum alloy, titanium alloy, or hard synthetic resin on the rectangular bar with narrow width. Two of the outer fixing sections 11, 11 are separated from each other by a prescribed distance so as to be the same as the stance width of the rider, and outer sides of both feet of the rider, when fixed by the bindings, are made to substantially match with the outer fixing sections 11, 11.

The supporting bar 11a has substantially the same length as the width of the snowboard 1 and is fixed by screws 13, 13.

Also the mounting bar 11b is formed shorter than the supporting bar 11a and is fixed on the supporting bar 11a by screws 14, 14. Individually holes are formed in the mounting bar 11b above the screws 13, 13, and outer nuts 19, 19 for mounting a binding 2 are fixed into these holes. These outer nuts 19, 19 are fixed by gluing, for example, after forming the mounting bar 11b.

The inner fixing section 15 is the second mounting seat of the present invention and comprises soft mounting parts 15a, 15a lined up at the right and left. Each of the soft mounting parts 15a, 15a is molded of flexible material such as rubber or polymeric elastomer.

A mounting hole 15b is opened in the central section of each soft mounting part 15a, and an insert nut 16 is embedded in the mounting hole 15b. The soft mounting part 15a is formed into a cylindrical shape with a substantially elliptic surface in cross-section so as to surround the mounting hole 15b. The insert nut 16 can be firmly fixed internally by forming integrally with the soft mounting part 15a or can be fixed by gluing in the soft mounting part 15a after molding.

In addition, an embedded bolt 17, on top of which a flange 17a is formed, is fixed below the soft mounting part 15a. The flange 17a is formed in an elliptic shape according to the shape of the soft mounting part 15a and is formed integrally with the soft mounting part 15a at the time of molding. By twisting the entire soft mounting part 15a so that the embedded bolt 17 is screwed into a bolt hole (not shown) formed in the snowboard, the soft mounting parts 15a is fixed onto the snowboard 1.

Incidentally, the shape of the cross-section of the soft mounting parts 15a is not limited to an ellipse shape, and it can also be a circle or a rectangle. Furthermore, the flange 17a may be altered according to the shape of the soft mounting parts 15a.

For each of the front mounting section 10a and the rear mounting section 10b of the structure for mounting bindings 10 in FIGS. 1 to 3, the binding 2 is mounted by fixing bolts of the binding 2 into the outer nuts 19, 19 and the insert nuts 16, 16.

According to the above described embodiment, the structure for mounting bindings 10 comprises the outer fixing sections 11 having the highly rigid supporting bars 11a and the highly rigid mounting bars 11b, and the inner fixing sections 15 having the highly flexible soft mounting parts 15a, 15a. With this structure, the following effects can be obtained.

Since the highly rigid outer fixing sections 11 are provided so as to cross the snowboard 1 and reached almost to the edges of the snowboard 1, shift in the direction of the weight of the rider is directly transmitted to the edges, the snowboard is directly responsive to a turn in the horizontal direction, and as a result, highly responsive performance can be achieved.

Meanwhile, although the outer fixing sections 11 with high rigidity are provided, since both of the supporting bars 11a and the mounting bars 11b are narrow in width and are in the state of crossing the snowboard 1 in the horizontal (widthwise) direction, without interfering with flex, that is bendability, of the snowboard 1 in the lengthwise direction and without causing a braking phenomena due to uneven deformation, the rider can ride the snowboard 1 while maintaining intended turning arcs.

Particularly, since the outer fixing sections 11, 11 are provided at substantially the same positions as the outer sides of both feet and the distance between the two outer fixing sections 11 is relatively long, when the rider is changes the direction of the snowboard 1 by twisting both feet, the snowboard 1 is made to twist having the outer fixing sections 11, 11 as both edges and therefore twisting the snowboard 1 can be carried out easily.

Then, because the inner fixing sections 15 provided inside of the each outer fixing sections 11 comprise the soft mounting parts 15a, 15a, the shapes of the inner fixing sections 15 vary according to the direction of the weight of the rider and the snowboard is fully bent without interfering with flex during riding.

Also, since the soft mounting parts 15a, 15a are only as big as to surround the mounting holes 15b, 15b, the response speed is not impaired.

Furthermore, when the outer fixing sections 11, 11 are provided at the outer side on the snowboard 1 and the inner fixing sections 15, 15 are provided at the inner side on the snowboard 1 and when the rider applies pressure to both feet, soles of both feet are naturally tilted toward the soft inner side or the center side of the rider, and thus the center of gravity of the rider naturally becomes the center of the snowboard 1, allowing the rider to maintain a stable position.

As described above, according to the structure for mounting bindings 10, by combining the highly rigid outer fixing sections 11, 11 and the highly flexible inner fixing sections 15, not only can the snowboard 1 be turned in the direction in which the rider intends to go due to the flex of the snowboard 1, but also highly responsive performance is achieved and riding performance can be improved.

Second Embodiment

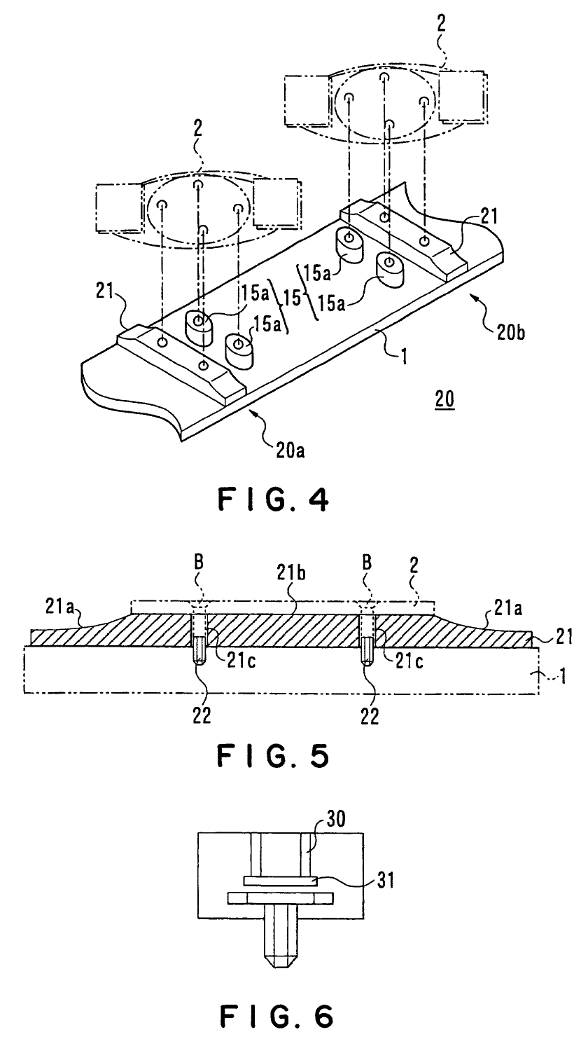

A structure for mounting bindings 20 is shown in FIGS. 4 and 5 as another example of the present invention. The same numerals are used for the same members as those in the first embodiment.

The structure for mounting bindings 20 comprises a front mounting section 20a and a rear mounting section 20b. Each of the front mounting section 20a and the rear mounting section 20b is made up of an outer fixing section (first mounting seat) 21 and an inner fixing section (second mounting seat) 15 provided at the inner side of the outer fixing section 21.

Each outer fixing sections 21 is molded of highly rigid material, the same as in the supporting bar 11a and the mounting bar 11b in FIG. 1. Although the overall length and width are about the same as those of the supporting bar 11a, the outer fixing section 21 is of a single member, which is different from FIG. 1. Therefore, the upper surface of the outer fixing section 21 becomes the mounting surface 21b for mounting the binding 20. As shown in FIG. 5, tapers 21a, 21a are formed in such a manner that the right and left edges of the outer fixing section 21 are inclined to the upward direction and continue to the mounting surface 21b.

Two outer mounting holes 21c, 21c are formed at the mounting surface 21b so as to penetrate the outer fixing section 21. By fitting bolts 22, 22 into the lower half of the outer mounting holes 21c, 21c and holes formed in the snowboard 1 (not shown), the outer fixing section 21 is fixed to the snowboard 1. In addition, nuts (not shown) are fixed in the upper half of the outer mounting holes 21c, and by screwing bolts B, B into these nuts, the binding 2 is fixed to the outer fixing section 21.

According to the above structure for mounting bindings 20, the same results can be obtained as in the structure for mounting bindings 10.

Incidentally, when comparing the structure for mounting bindings 10 with 20, in the structure for mounting bindings 20, since the outer fixing section 21 is of one member, the manufacturing process can be omitted to a certain extent and costs can be reduced. On the other hand, in the structure for mounting bindings 10, since the outer fixing section 11 is made up of the supporting bar 11a and the mounting bar 11b, it is more likely to be responsive to the bendability of the board 1 by structuring the highly rigid outer fixing sections 11 made of two members rather than one member.

Incidentally, the present invention is not limited to the first and the second embodiments.

For example, the insert nut of the soft mounting part, as shown in FIG. 6, can be a type of nut 30, on top of which a flange 31 is provided. Because the flange 31 is provided, the nut 30 will not easily come off.

Further, although alpen type bindings are shown in FIGS. 1 to 7, the present invention can also be applied to those for other types, such as free style. Suitable modifications are obviously also possible to the specific structural details etc.

According to the structure for mounting the bindings of the present invention, the outer sides of the bindings are mounted at the first mounting seats made of the rigid members, and the inner sides at the second mounting seats made of the soft members. Therefore, since the outer sides of the bindings are mounted on the snowboard via the first highly rigid mounting seats, shifting the direction of the weight of the rider is directly transmitted to the snowboard, and the snowboard is directly responsive to a turn in the horizontal direction, as a result, high responsive performance can be achieved.

Since the inner side of the bindings are mounted on the snowboard via the second soft mounting seats, the shape of the second mounting seats freely varies according to the direction of the weight of the rider during riding, and flex of the snowboard is not interfered with. As a result, the tuning arc can be maintained as the rider intends.

As described above, by combining the first highly rigid mounting seats and the second highly flexible mounting seats, not only can the snowboard be fully bent and turned in the direction in which the rider intends to go, but it also exhibits quick response, and the riding performance can be improved.

What is claimed is:

1. A structure for mounting snowboarding bindings on a snowboard, comprising:
a pair of first mounting seats made of hard members provided on the snowboard in a lengthwise direction being separated from each other by a prescribed distance, and
a pair of second mounting seats made of soft deformable members provided at inner sides of the first mounting seats.

2. The structure for mounting the snowboarding bindings according to claim 1, wherein:
the first mounting seats are mainly made of either aluminum alloy, titanium alloy, or bard synthetic resin and formed into a bar shape or a plate shape, and:
the second mounting seats are mainly made of either rubber or polymeric elastomer and formed into a cylindrical shape or an elliptical shaft shape.
